(19) United States
(12) Patent Application Publication
(10) Pub. No.: US 2013/0052395 A1
(43) Pub. Date: Feb. 28, 2013

(54) COMPOSITE COMPONENT HAVING A MULTILAYER CAP

(71) Applicants: Brian R. Davis, Columbus, OH (US); Bryan K. Buhrts, Wilmington, OH (US); Scott A. Haemmerle, Cincinnati, OH (US); William G. Taylor, Columbus, OH (US); Jessica A. Alessandro, Dublin, OH (US)

(72) Inventors: Brian R. Davis, Columbus, OH (US); Bryan K. Buhrts, Wilmington, OH (US); Scott A. Haemmerle, Cincinnati, OH (US); William G. Taylor, Columbus, OH (US); Jessica A. Alessandro, Dublin, OH (US)

(73) Assignee: TimberTech Limited, Wilmington, OH (US)

(21) Appl. No.: 13/590,143

(22) Filed: Aug. 20, 2012

Related U.S. Application Data
(60) Provisional application No. 61/525,690, filed on Aug. 19, 2011.

(51) Int. Cl. B32B 3/04; B32B 27/30; B32B 27/08; B32B 27/32

(52) U.S. Cl. 428/76; 428/523; 428/507; 428/518; 428/424.6

(57) ABSTRACT

A component comprised of a substrate and a multilayer cap. In one example, the inner cap layer may be a material that is typically not considered to be suitable for use with the substrate. In another example, the substrate may be provided with at least two different cap layers to gain the benefits of each cap layer.

This application claims the benefit of U.S. Provisional Application No. 61/525,690, filed on Aug. 19, 2011, which is hereby incorporated by reference in its entirety.

### BACKGROUND AND SUMMARY OF THE INVENTION

Exemplary embodiments of the present invention relate generally to components comprised of capped materials and components and, more particularly, to materials and components that have a multilayer cap. One particular embodiment relates to components made from wood replacement materials such as organic-filled and/or inorganic-filled composite components. However, unless expressly set forth otherwise, it is not intended to limit the present invention to a particular type or category of components. The exemplary components of the present invention may be substituted for components typically made of wood, particle board, wafer board, or other similar materials. In addition, it should be recognized that exemplary components of the present invention may be substituted for components commonly made of other materials such as, but not limited to, metal, plastic, single layer extrusions, molding materials, and other materials used presently or in the past or future to make components.

The supply of natural woods for construction and other purposes is dwindling. As a result, many are concerned about conserving the world's forests, and the cost of natural woods has risen. In light of these factors, a tremendous demand has developed in recent years for wood composites, e.g., cellulosic/polymer composites, that exhibit the look and feel of natural woods. Although improvements and developments are still being made, it is known in the art how to make wood replacement products. For example, U.S. Pat. Nos. 3,908,902, 4,091,153, 4,686,251, 4,708,623, 5,002,713, 5,055,247, 5,087,400, and 5,151,238 relate to processes for making wood replacement products.

Wood composites may typically be formed through an extrusion process. Extrusion involves mixing or blending the ingredients of a wood composite material with any conventional mixing device or industrial blender. The materials may then be delivered to a heated extruder where they are processed at a suitable speed and temperature. In the extruder, the materials may be blended and heated and then forced into a die system. The die system can be made up of one or more plates. The die system allows the starting materials to bond and form a shaped-homogeneous product.

An example of a co-extrusion system is described in U.S. Pat. No. 6,793,474, which is incorporated herein by reference, in its entirety. Other types of co-extrusion systems are also known in the art. Such systems have had limited uses, so there is a need for new uses of co-extrusion systems.

Wood composites can offer many advantages as compared to natural wood. For instance, wood composites can offer superior resistance to wear and tear. In particular, wood composites can have enhanced resistance to moisture. In fact, it is well known that the retention of moisture is a primary cause of the warping, splintering, and discoloration of natural woods. Moreover, wood composites may be sawed, sanded, shaped, turned, fastened, and finished in a similar manner as natural woods. Also, wood composites can be embossed or otherwise textured to promote a wood grain appearance.

There are many different wood composite materials. Each wood composite material has specific characteristics including, but not limited to, appearance, durability, workability, flexibility, weight, resistance to moisture, resistance to cracking and splintering, resistance to expansion and contraction, resistance to discoloration, mildew resistance, ultraviolet light screening ability, etc.

Despite the many advantages of wood composites in comparison to natural woods, there is a need to be able to provide a cap on wood composites. For example, a wood composite may not provide the desired physical or aesthetic characteristics for some applications. In one instance, it may be too costly to incorporate desired additives throughout the wood composite to get a component having desired properties. In another instance, a wood composite may be a more widely available or better alternative for a substrate. In still other instances, a cap may simply be more cost effective or provide improved aesthetics or physical characteristics as compared to the substrate.

There is a further need to be able to provide a particular capstock on certain substrates. Certain capstocks are typically considered unsuitable for certain substrates. In other words, material groups are not mixed. A particular example is that a PVC-based capstock is typically not considered suitable for a polyethylene-based substrate; instead, a PVC-based capstock is put on a PVC substrate. Consequently, some materials have not been considered suitable for better capstocks.

There is still a further need to improve on existing capped components. Particular capstocks may be advantageous with respect to some characteristics and deficient in others. As a result, existing caps may not provide desired performance over a period of time.

Exemplary embodiments of the present invention may address some or all of the aforementioned needs. In an exemplary embodiment, a substrate is provided with a multilayer cap. In one example, the initial (first) cap layer may be a material that is typically not considered to be suitable for use with the substrate. In another example, the substrate may be provided with at least two different cap layers to gain the benefits of each cap layer. In exemplary embodiments, the combination of cap layers may provide surprising and unexpected results that are a significant improvement over that which can be obtained with only one of the cap layers.

In one exemplary embodiment, a polyethylene-based composite substrate may be provided with a PVC capstock. A tie layer may secure the PVC capstock to the substrate. An example of a tie layer is ethylene vinyl acetate (EVA). In an exemplary embodiment, a UV-cured coating may then be provided about the PVC capstock. An example of a UV-cured cap is a blend of urethane and acrylic (e.g., urethane acrylates that are 100% solids). While this embodiment is particularly useful, other materials and combinations are possible.

In addition to the novel features and advantages mentioned above, other benefits will be readily apparent from the following descriptions of the drawings and exemplary embodiments.

### BRIEF DESCRIPTION OF THE DRAWINGS

FIG. 1 is a cross section of an exemplary embodiment of a component of the present invention.

FIG. 2 is a cross section of another exemplary embodiment of a component of the present invention.

### DETAILED DESCRIPTION OF EXEMPLARY EMBODIMENT(S)

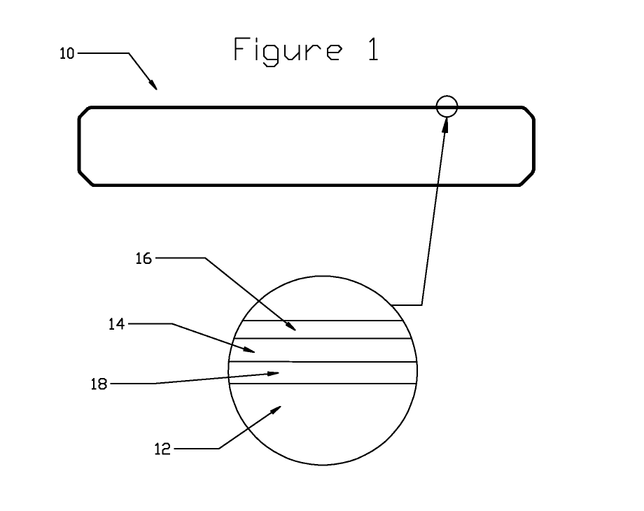

Exemplary embodiments of the present invention are directed to capped materials and components. Exemplary embodiments may also include methods for manufacturing the capped materials and components. FIG. 1 shows one exemplary embodiment of a component of the present invention. In this exemplary embodiment, the component may be a deck board 10 comprising a substrate 12, a first cap layer 14, and a second cap layer 16. In this example, the first cap layer 14 extends around all four sides of the deck board 10. In other exemplary embodiments, the first cap layer 14 may be disposed on any side or sides of the component 10. The second cap layer 16 at least partially overlaps the first cap layer 14. In an exemplary embodiment, the second cap layer 16 may extend over substantially all of the first cap layer 14. FIG. 1 shows an example in which the second cap layer 16 extends completely around all sides of the component 10 and substantially covers first cap layer 14. Unless expressly set forth otherwise, the cap layers may respectively have any suitable thickness. Nonetheless, in an exemplary embodiment, each cap layer may have a conventional capstock thickness. Also, some exemplary embodiments may include more than two cap layers. By providing multiple cap layers, surprising and unexpected aesthetic and physical characteristics may be obtained that are not available with only one of the cap layers.

The component 10 may also include at least one tie layer to secure layers together. One example of a tie layer is ethylene vinyl acetate. Other materials that may be suitable for use as a tie layer include other polymers and adhesives. In the example shown in FIG. 1, a tie layer 18 is provided between substrate 12 and first cap layer 14 to assist with securing first cap layer 14 to substrate 12. Such an embodiment may allow for the use of a first cap layer that is typically not considered to be suitable for use with the substrate for reasons including, but not limited to, resin incompatibility. Another tie layer may also be provided between first cap layer 14 and second cap layer 16 to assist with securing the two cap layers together. In other embodiments, resin compatibility may be sufficient to secure adjacent layers together.

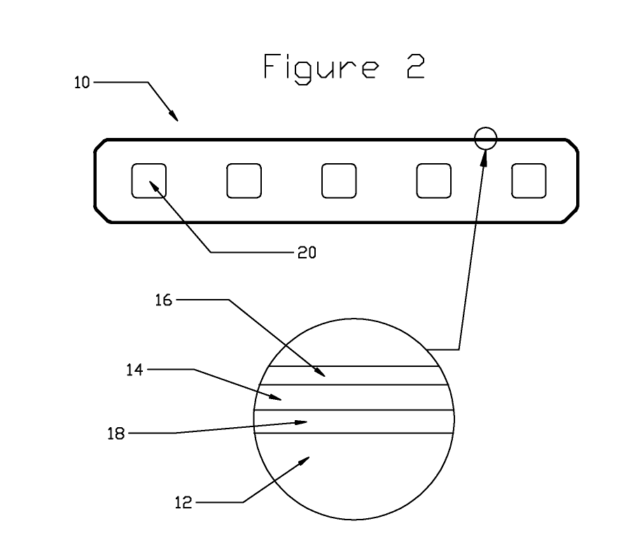

FIG. 2 shows another exemplary embodiment of a deck board 10. In this example, the deck board 10 may include at least one hollow 20. This example may otherwise be similar to the embodiment shown in FIG. 1.

Although one exemplary embodiment is particularly useful for a deck board, other components that may be formed by exemplary embodiments of the present invention may include various other planks and railing components including, but not limited to, top rails, universal rails, balusters, post sleeves, inside corner molding, and other railing components. Further examples of components that may benefit from the present invention include siding, siding accessories, interior and exterior decorative house moldings, crown moldings, chair rails, baseboards, door moldings, picture frames, furniture components, deck components, deck railings, window moldings, window components, window lineals, window frames, door components, door frames, roof components, fence components, fence posts, fence rails, floor components, pergolas, lattices, and other suitable indoor and outdoor items. In addition, exemplary embodiments of the present invention may be used to manufacture of other types of products that are commonly made from wood, composites, metal, or plastic.

Unless specified otherwise, exemplary embodiments of a component of the present invention may contemplate many variations of the materials used for a substrate and cap layers. For example, a substrate may be formed from plastic, organic-filled composite (e.g., wood composite), inorganic-filled composite, regrind, foamed composite, or any combination thereof. In certain exemplary embodiments, organic-filled and/or inorganic-filled composites are integral because each may not provide the desired aesthetic and physical characteristics that may be obtained with the capstock layers. For example, such filled composites may be more cost effective in comparison to similar unfilled materials, but may lack desired appearance or physical characteristics.

A cap layer may also be formed from plastic. Some examples of a cap layer may also include organic or inorganic filler, lubricant, stabilizer, weathering additives, process aid, pigments, and other additives. Other embodiments of a plastic cap may not include organic or inorganic filler. The plastic cap layers may be used to transform a composite substrate such that the component has desired aesthetic and physical characteristics. However, unless specified otherwise, other substrates may also benefit from multiple cap layers, which may or may not include fillers.

Any desired wood composite materials may be used in exemplary embodiments of a composite substrate including, but not limited to, plastic/cellulosic filler materials, polymer/cellulosic filler materials, thermoplastic/cellulosic filler materials, rubber/cellulosic filler materials, foamed wood composite materials, and other cellulosic composite materials that are known now or in the future. For instance, the materials used to make an exemplary composite substrate may include, but are not limited to, cellulosic fillers, polymers, plastics, thermoplastics, rubber, inorganic fillers, cross-linking agents, lubricants, process aids, stabilizers, accelerators, inhibitors, enhancers, compatibilizers, blowing agents, foaming agents, thermosetting materials, colorants, and other similar or suitable materials.

Examples of cellulosic fillers include sawdust, newspapers, alfalfa, wheat pulp, wood chips, wood fibers, wood particles, ground wood, wood flour, wood flakes, wood veneers, wood laminates, paper, cardboard, straw, cotton, rice hulls, coconut shells, peanut shells, bagass, plant fibers, bamboo fiber, palm fiber, kenaf, flax, wheat, wheat straw, and other similar or suitable cellulose materials. Any of the wood examples may be hard or soft wood or variations thereof. Furthermore, any desired mesh size of the cellulosic filler may be used. With regard to wood flour, an exemplary range of mesh size is about 10 mesh to about 100 mesh, more preferably about 40 mesh to about 80 mesh depending on the desired characteristics of the material.

On the other hand, examples of polymers include multilayer films, high density polyethylene (HDPE), polypropylene (PP), polyvinyl chloride (PVC), low density polyethylene (LDPE), chlorinated polyvinyl chloride (CPVC), acrylonitrile butadiene styrene (ABS), acrylonitrile styrene acrylate (ASA), ethylene vinyl acetate (EVA), polystyrene (PS), other similar copolymers, other similar or suitable plastic materials, and formulations that incorporate any of the aforementioned polymers. For instance, examples of substrate material include, but are not limited to, foamed polypropylene, foamed polystyrene, and polyethylene hollows.

Examples of inorganic fillers include talc, calcium carbonate, kaolin clay, magnesium oxide, titanium dioxide, silica, mica, barium sulfate, feldspar, diatomite, fly ash, recycled rubber, and other similar or suitable materials. Examples of thermosetting materials include polyurethanes, such as isocyanates, phenolic resins, unsaturated polyesters, epoxy resins, and other similar or suitable materials. Combinations of the aforementioned materials are also examples of thermosetting materials. Examples of lubricants include zinc stearate, calcium stearate, esters, amide wax, paraffin wax, ethylene bis-stearamide, and other similar or suitable materials. Examples of stabilizers include tin stabilizers, lead and metal soaps such as barium, cadmium, and zinc, and other similar or suitable materials. In addition, examples of process aids include acrylic modifiers and other similar or suitable materials.

Examples of blowing agents include endothermic and exothermic chemical foaming agents or combinations thereof. Examples of an endothermic blowing agent include HYDROCEROL™, sodium bicarbonate, and other similar or suitable materials. HYDROCEROL™ blowing agent is available from Boehringer Ingelheim in Petersburg, Va. Other blowing agents may be a combination of endothermic and exothermic (e.g., azodicarbonamide and other similar or suitable materials). Other suitable blowing agents known to one of ordinary skill in the art may also be utilized in exemplary embodiments of the present invention. For example, EXPANCEL™ microspheres are an example of a blowing or foaming agent that is commercially available from Expancel, Inc., which is a company of Akzo Nobel.

One exemplary embodiment of a cellulosic composite material for a substrate may include at least one cellulosic filler in an amount of about 30% to about 70% by weight, more preferably about 40% to about 60% by weight, and still more preferably about 40% to about 50% by weight. The composite may also include polyethylene in an amount of about 25% to about 40% by weight, more preferably about 25% to about 35% by weight, and still more preferably about 30% to about 35% by weight. The composite may also include talc or another suitable inorganic filler in an amount of about 1% to about 20% by weight, more preferably about 5% to about 15% by weight, and still more preferably about 10% to about 15% by weight. The composite may also include lubricant in an amount of about 3% to about 6% by weight. Other additives may also be included in the composite.

Another exemplary embodiment of a wood composite material may include at least one cellulosic filler in the amount of about 30% to about 70% by weight, more preferably about 40% to about 60% by weight, and still more preferably about 45% to about 55% by weight. The composite may also include polyethylene in the amount of about 25% to about 45% by weight, more preferably about 25% to about 35% by weight, and still more preferably about 28% to about 33% by weight. The composite may also include talc or another suitable inorganic filler in an amount of about 5% to about 25% by weight, more preferably about 10% to about 20% by weight, and still more preferably about 12% to about 17% by weight. The composite may also include lubricant in an amount of about 1% to about 10% by weight and more preferably about 3% to about 8% by weight.

It should also be recognized that, for any of the examples, a substrate may be comprised of a regrind composite. These exemplary embodiments enable a regrind composite to be used in a manner such that the regrind composite layer is less visible or not visible due to the multiple cap layers. As a result, a regrind composite may be used even if it does not provide the desired appearance. For instance, a regrind composite may still be used even if it is not comprised of the desired pigment. Indeed, multiple different types of regrind material may be mixed together to form the regrind composite layer in each of the examples. The differences between the types of regrind material may be the ingredients and/or the amounts of the ingredients. For example, various colors of regrind material may be mixed together to form a substrate. In such embodiments, the cap layers may be selected to provide the desired appearance or other physical or aesthetic characteristics. For example, the cap layers may be pigmented to provide the desired appearance.

One exemplary embodiment of a component includes a first cap layer comprised of a resin that is not compatible with the resin of the substrate. In one exemplary embodiment, a PVC-based capstock may be used with a polyethylene-based substrate. One example of PVC-based capstock may include PVC resin, stabilizer, titanium dioxide (TiO₂), lubrication, process aid, and pigment. Benefits of PVC-based capstock may include improved weatherability (e.g., color retention) and impact resistance.

Another exemplary embodiment of a component may include a first capstock layer that is thermoplastic and a second capstock layer that is thermoset. An example of a second capstock layer is a UV-cured coating. One embodiment of a UV-cured coating is a blend of urethane and acrylic (e.g., urethane acrylates that are 100% solids). An example of a UV-cured coating may offer advantages including, but not limited to, water repellency, impact resistance, reduced cracking/brittleness, scratch resistance, chemical resistance, UV resistance, and resistance to yellowing. An example of a UV-cured coating may be clear (e.g., transparent or translucent) so as to allow the appearance of the first capstock layer. However, in some exemplary embodiments, a UV-cured coating may include pigments (e.g., such that the first capstock layer cannot be seen or such that the first and second capstock layers create a layered appearance.

In an exemplary embodiment, each of the capstock layers may provide particular advantages. At the same time, a capstock layer may also help to compensate for or improve aspects of the other capstock layer(s). In an exemplary embodiment, the end result may be a component that exhibits better physical and aesthetic characteristics than a similar component with fewer or no capstock layers. In addition, more expensive additives such as ultraviolet light protection materials, anti-staining materials, and higher grade pigments may be less needed and/or may be added in smaller amounts to the cap layers because of the improved performance achieved with multiple cap layers, which may thus reduce the cost of the component.

A component of one exemplary embodiment of the present invention may be formed by any suitable method. For example, a component may be made using one or more manufacturing methods including, but not limited to, extrusion, co-extrusion, pultrusion, compression molding, spraying, brushing, and other similar or suitable manufacturing methods. For example, each of the layers may be co-extruded. Alternatively, layers may be provided in multiple stages.

Any embodiment of the present invention may include any of the optional or preferred features of the other embodiments of the present invention. The exemplary embodiments herein disclosed are not intended to be exhaustive or to unnecessarily limit the scope of the invention. The exemplary embodiments were chosen and described in order to explain some of the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A component comprising:
a substrate;
a first cap layer on said substrate, said first cap layer comprised of polyvinyl chloride; and
a second cap layer on said substrate, said second cap layer being a UV-cured cap.

2. The component of claim 1 wherein said substrate is comprised of a cellulosic-filled polymer composite.

3. The component of claim 2 wherein said cellulosic-filled polymer composite is comprised of polyethylene.

4. The component of claim 1 wherein said substrate is comprised of an inorganic-filled polymer composite.

5. The component of claim 4 wherein said inorganic-filled polymer composite is comprised of polyethylene.

6. The component of claim 1 wherein a resin of said substrate is not compatible with said polyvinyl chloride of said first cap layer.

7. The component of claim 1 wherein said first cap layer is further comprised of stabilizer, titanium dioxide (TiO₂), lubrication, process aid, and pigment.

8. The component of claim 1 wherein said UV-cured cap is comprised of urethane.

9. The component of claim 8 wherein said UV-cured cap is comprised of urethane acrylate.

10. The component of claim 1 wherein said UV-cured cap is clear.

11. The component of claim 1 wherein said first cap layer is secured to said substrate by a tie layer.

12. The component of claim 11 wherein said tie layer is comprised of ethylene vinyl acetate.

13. The component of claim 1 wherein said first cap layer is situated between said substrate and said second cap layer.

14. The component of claim 1 wherein said first cap layer and said second cap layer are on at least one side of said substrate.

15. The component of claim 1 wherein said component is a deck board.

16. A component comprising:
a substrate;
a first cap layer on said substrate; and
a second cap layer on said substrate;
wherein said first cap layer is thermoplastic and said second cap layer is thermoset.

17. The component of claim 16 wherein said substrate is comprised of polyethylene.

18. The component of claim 17 wherein said polyethylene is not compatible with a resin of said first cap layer.

19. The component of claim 17 wherein:
said first cap layer is comprised of polyvinyl chloride; and
said second cap layer is a UV-cured cap.

20. A deck board comprising:
a substrate comprised of a cellulosic-filled polyethylene composite;
a first cap layer on said substrate, said first cap layer comprised of polyvinyl chloride; and
a second cap layer on said substrate such that said first cap layer is situated between said substrate and said second cap layer, said second cap layer comprised of urethane acrylate;
wherein said first cap layer and said second cap layer extend completely around said substrate.
